(19) United States
(12) Patent Application Publication
(10) Pub. No.: US 2021/0178964 A1
(43) Pub. Date: Jun. 17, 2021

(54) WARNING SYSTEM FOR STANDING VEHICLES

(71) Applicants: Moshe KILIM, Gan Soreq (IL); Avraham BACHAR, Tiqwa (IL); Yom-Tov (Tobi) Shamesh, Gan Soreq (IL)

(72) Inventors: Moshe KILIM, Gan Soreq (IL); Avraham BACHAR, Tiqwa (IL); Yom-Tov (Tobi) Shamesh, Gan Soreq (IL)

(21) Appl. No.: 16/081,393

(22) PCT Filed: Mar. 7, 2017
(86) PCT No.: PCT/IL17/50278

§ 371 Date: Aug. 30, 2018

Related U.S. Application Data
(60) Provisional application No. 62/310,908, filed on Mar. 21, 2016.
(60) Provisional application No. 62/426,023, filed on Nov. 23, 2016.

(51) Int. Cl. B60Q 7/00; B60Q 1/52; B60Q 1/26; G09F 13/16

(52) U.S. Cl. CPC B60Q 7/00; B60Q 1/525; G09F 13/16; B60Q 1/2615; B60Q 1/268

(57) ABSTRACT

Some examples of an active-alerting apparatus (AAA) are disclosed. The AAA is configured to be associated with a standing vehicle. Some embodiments of the AAA can have a structure of a flag (AAF) other embodiments of AAA can have a structure of a triangle (AAT) other can have a structure of a folding triangle (FAAT). Examples of AAA can be associated to a window of the standing vehicle or to an adaptor for holding the AAA. The adaptor can be a pip that is associated with the back of the wagon and is configured to hold the AAA such that the AAA faces the coming traffic. The AAA can be associates with retro-reflecting red area, red-fluorescent area and one or more light sources, such as LEDs.

### CROSS-REFERENCE TO RELATED APPLICATIONS

The current application claims priority to the following U.S. Provisional Application for Patent No. 62/310,908 filed on Mar. 21, 2016 and entitled “WARNING SYSTEM FOR STANDING VEHICLES” and to U.S. Provisional Application for Patent No. 62/426,023 filed on Jan. 27, 2017 and entitled “WARNING SYSTEM FOR STANDING VEHICLES”. Both applications are incorporated by reference in their entirety.

### TECHNOLOGY FIELD

The present disclosure generally relates to the field of safety for standing vehicles and vehicles approaching the standing vehicles.

### BACKGROUND

Once in a while a driver of a vehicle is forced to stop on a road or a traffic lane. Such stops could be caused by different driver and/or passenger needs or technical conditions of the vehicle. In some cases the vehicle can be driven to the shoulders of the road. However, there are cases in which the vehicle cannot be moved to the shoulders of the road or at least a part of the vehicle remains on the traffic lane. As used in the current disclosure the term “road” or “traffic lane” means a surface upon which vehicles drive. The terms could be used interchangeably. As used in the current disclosure the term “shoulder” means an area between the road and a ditch providing the road a lateral support.

A standing vehicle is an obstacle on the way of vehicles that use the same road or traffic lane. It was founded that one of the most critical reasons for car accidents, with casualties, is a standing vehicle and the worst accidents are caused by standing trucks or even standing track trailers pulled by a truck.

In order to avoid accidents with a standing vehicle an Alerting-Triangle (AT) traffic is commonly used. The alerting triangle comprises a triangle with light reflecting red material. A driver of a standing car is required to place the alerting triangle on the road between the standing vehicle and the incoming traffic. Usually the AT is placed few meters behind the rear end of the standing vehicle and facing the incoming traffic. Placing the alerting triangle on the road may put the driver of the standing vehicle in a danger situation.

Quite often, cars, which are driven over the same traffic lane, where the standing vehicle is parked, may pass over the alerting triangle, throw it away from the road or even destroy it, preventing the alerting indication to be viewed by the incoming vehicles. In addition, the reflection material is passive and is effective only when light, emitted by incoming vehicles, flashes over the reflection material. Sometimes, the reflection could be detected when the incoming vehicle is too close to the standing vehicle and it is too late for changing the traffic lane or stopping, especially when the incoming vehicle travels over crowded roads.

Absence of the alerting triangle could cause traffic accidents, therefore, there is a need for an improved alerting triangle for indicating that a vehicle is standing on the road.

### SUMMARY

The needs and the deficiencies that are described above are not intended to limit the scope of the inventive concepts of the present disclosure in any manner. The needs are presented for illustration purposes only. In addressing the above-described needs in the art, as well as other needs and/or short-comings in current alerting devices, the present disclosure presents an active-alerting system (AAS) or device. In one example the AAS may be an active-alerting flag (AAF). An example of AAF could include a rod associated with a piece of cloth or fabric. The piece of cloth could be attached by one edge to the rod, where the second edge of the cloth is usually free. In some examples, the active-alerting flag can include one or more light reflecting bands or stripes. In some examples, one or more light sources could be associated or embedded in the active-alerting flag. An example of such light sources could be LEDs (Light-Emitting Diode), laser diodes, Organic Light Displays (OLEDs).

In some examples of the active-alerting flag the light source or sources could be distributed over the length of the rod of the active-alerting flag or be associated with one end of the rod. In other examples the light source can be placed at the far end of the rod closest to the near traffic lane. In other examples the one or more light source can be associated with the rod and with the fabric of the flag.

In some examples, the fabric of the active-alerting flag can be made of high strength polyester material and be attached to a vehicle with the help of a polypropylene pole and a clip-on-vehicle mechanism (CVM). In some examples the clip-on-vehicle mechanism can comprise a clip-on-window mechanism (CWM). In order to attach the active alerting flag to the door or to the roof of a vehicle, a variety of clip-on-vehicle mechanisms, such as a magnetic mechanism, a vacuum mechanism or similar could be used. The active-alerting flag pole can be arranged such that the fabric or polyester material of the active-alerting flag falls substantially perpendicular to the road facing the incoming traffic. As used in the present disclosure and the claims the terms pole, arm and rod can be used interchangeably.

Energy source to power the light sources could be one or more batteries. In some examples, the batteries could be embedded or associated with the bottom edge of the fabric of the active alerting flag and the batteries could be used also as weights to constantly pull the fabric of the flag down for fully display the flag to the incoming traffic. In other examples, the batteries can be associated with the rod of the flag. In such examples one or more weights can be associated with the fabric of the active alerting flag. In an additional example, the energy required for operation of light sources can be obtained from the vehicle battery. The light sources could be connected to the cigarette-lighting-plug (CLP) of the vehicle.

In some examples a stress-release mechanism (SRM) or an impact dumping mechanism could be included in the flag pole or in the clip-on-window mechanism. The impact dumping mechanism can be configured to absorb shocks that could be caused by passing vehicles and isolate the flag from the part of the vehicle to which it is attached. Thus, protecting the vehicle and the flag form punches from passing cars. A spring that connects the rod of the flag to the clip-on-window mechanism could be an example of a stress-release mechanism or an impact dumping mechanism. In other example a series of holes or slots forming in the flag pole a perforation like pattern to form and easy to brake line in the flag pole.

Long trucks or truck trailers may need to place the active alerting flag at the back of a standing truck or truck trailer. To facilitate the active alerting flag placement, an adaptor for receiving the active alerting flag could be associated or attached to the back of the truck or truck trailer. The adaptor could be configured to allow the fabric of the active alerting flag fall down in a substantially vertical position and facing the incoming traffic.

In one example, the adaptor can be a letter U-shaped article with one upright member associated with the truck and the other upright member can simulate the top edge of the window.

In another example the active-alerting system could be configured as an active-alerting triangle. In one example the active-alerting triangle can comprise three bars. The three bars are configured such that the assembly of the three bars forms an active alerting triangle. One or more of the bars can be associated with retro-reflecting red area (RRRA). In some embodiments of the active-alerting triangle, one or more bars can be associated with retro-reflecting red area and red-fluorescent area (RFA). Yet, in another example of active-alerting triangle one or more of the bars can be associated also with one or more light sources, such as but not limited to LEDs. The sources of light could be emitting a red color or yellow color or a combination of the red and yellow colors.

Each of the three bars forming the active alerting triangle can be divided into two or more segments. The segments are connected by a joint allowing the bars to be folded to half or third of the bar size, depending on the number of segments that form the bar. The folding active alerting triangle (FAAT) can include an elastic cable threaded through the segments of the three bars. In other examples an elastic element can be placed in association with one or more of the joints. The elastic cable or element can be configured to pull the folded bars and expand the active alerting triangle into a triangle shape that could be attached to a standing vehicle or be placed on the road.

In addition, the structure of the folded active alerting triangle that includes the elastic cable or member facilitates absorption of impact that could be caused by passing traffic.

In an additional example, the active alerting triangle can be associated with a rod. The rod can be configured to associate the active alerting triangle with a standing vehicle. In some embodiments, the rod can be a telescopic rod that can be adjusted to a proper length by a driver of a standing vehicle. The rod could be attached to the standing vehicle window by a clip-on-window mechanism. In another example a magnetic mechanism could be used to attach the active alert triangle to a door or the roof of the standing vehicle. In still a further example the clip-on-vehicle mechanism may use a vacuum mechanism in order to attach the active alerting triangle to the vehicle.

In a further example the rod can be adapted to support the active alerting triangle when it is placed on the road in between incoming traffic and a standing vehicle.

The above summary is not intended to summarize each potential embodiment or every aspect or any advantage of the present disclosure.

### DESCRIPTION OF THE DRAWINGS

A more complete understanding of the present disclosure and the advantages thereof will be understood and appreciated by referring the following description in consideration of the accompanying drawings in which like reference numbers indicate like features and parts:

FIGS. 1A and 1B illustrate examples of a standing vehicle with an active alerting flag;

FIGS. 2A and 2B, illustrate examples of a telescopic-rod of an active alerting flag;

FIG. 3 illustrates an example of a telescopic-rod to be mounted on a bus or a trailer of a truck;

FIGS. 4A, 4B, 4C and 4D each one shows an example of an adaptor for holding the active alerting flag at a side of a truck or track trailer;

FIG. 5 illustrates an example of a telescopic-rod of an active alerting flag attached to a window of a truck;

FIGS. 6A and 6B illustrate examples of an adaptor for holding the active alerting flag on the back of a truck;

FIGS. 7A, 7B, 7C and 7D are illustrating different states an example of a folding active-alerting triangle; and

FIGS. 8A, 8B and 8C illustrate another example of a folding active-alerting triangle.

### DESCRIPTION

Absence of a proper alerting triangle or flag traffic sign could cause traffic accidents on the road. Studies indicate that drivers react more quickly to road signs with symbols depicting motion or including images varying in time. Therefore, there is a need in an improved alerting triangle to indicate that a vehicle is standing on the road.

In addressing the above-described needs, as well as other needs and/or short-comings in current traffic alerting devices, the present disclosure presents an active-alerting system. In some examples of the present disclosure the active-alerting system may comprise an active-alerting flag.

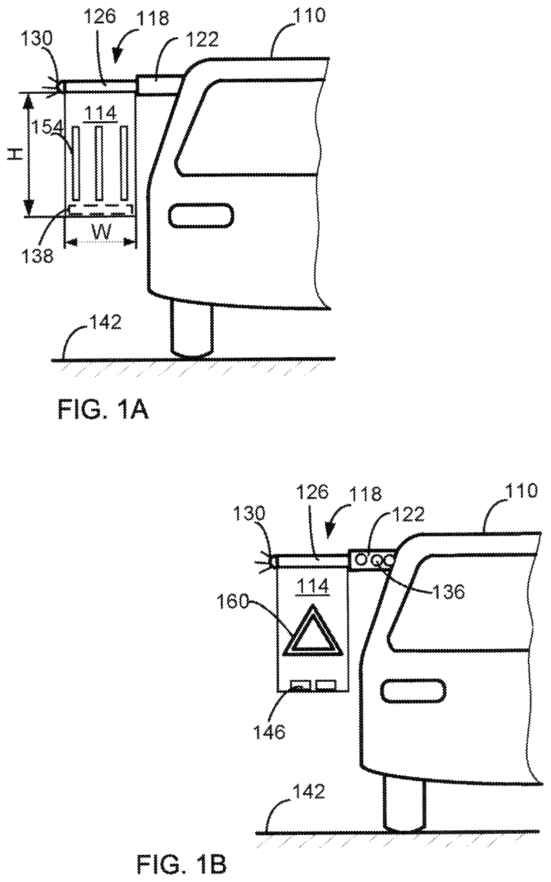

FIG. 1A shows a back view of a standing vehicle, which could be a car 110. With the help of rod 118 active-alerting flag 114 is associated or at least temporarily attached to standing car 110. In one example rod 118 is a telescopic-rod including an external member 122 and an internal member 126. In use, internal member 126 could be pulled on a desired length from external member 122.

A light source 130 can be mounted on distal end of rod 118. Light source 130 could include for example one or more LEDs emitting red light or yellow light. Alternatively, light source 130 could include a number of laser diodes emitting red light.

In another example, illustrated in FIG. 1B, telescopic rod could include a number of light sources 136 distributed along external member 122, although in some examples light sources 136 could be distributed along both external member 122 and internal member 126.

Active-alerting flag 114 could be made of a piece of cloth or high strength cotton or other material fabric. Alternatively, active-alerting flag 114 could be made of high strength polyester or other synthetic material. The width (W) of the fabric of active-alerting flag 114 could be few tens of centimeters, for example 30 to 70 centimeter. In some examples the width of the fabric could be 50 centimeters. The height (H) of the fabric from which active-alerting flag 114 is made can be few tens of centimeters, could be 50 to 100 centimeters, and frequently the height of the fabric could be 70 centimeters.

In some examples of active-alerting flag 114, the bottom edge of the fabric could include one or more weights 138 that drop down the fabric of active-alerting flag 114 and keep the fabric substantially perpendicular to road 142, such that it is well visible to the incoming traffic. In an additional example, weights 138 can be replaced by one or more batteries 146 that are used to energize light sources 130 and 136. In still a further example, batteries 146 can be associated with internal member 120 of rod 118. Yet, in an additional example, the energy required for operation of light sources 130 and 136 can be obtained from the accumulator of the car to which light sources 130 could be connected using for example a cigarette-lighting-plug (CLP) of the car.

In some examples, the fabric from which active-alerting flag 114 is made, could include one or more light reflecting bands or stripes 154 (FIG. 1A). In an additional example, light reflecting bands 154 could be replaced by a triangle 160. In some examples, light reflection bands 154 and triangle 160 can be associated or include light sources such as for example LEDs.

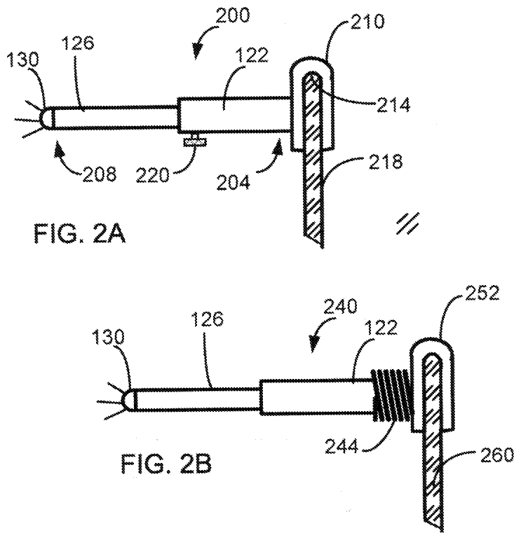

FIGS. 2A-2C, illustrate examples of a telescopic-rod 200 of an active alerting flag. FIG. 2A illustrates a side view of an example of a telescopic-rod 200 of an active-alerting flag. Telescopic rod 200, in addition to earlier disrobed elements, includes a proximal to the standing vehicle end 204 and a distal end 208. Proximal to the standing vehicle end 204 of telescopic rod 200 could be configured to include a clip-on-window mechanism 210. Clip-on-window mechanism 210 supports association of telescopic rod 200 with the top edge 214 of a vehicle window 218 that is closest to the next traffic lane of the incoming traffic. For example, the window of the driver, when it is the closest to the traffic lane of the incoming traffic.

Typically, the cross section external member 122 and of internal member 126 of telescopic rod 200 would be a round cross section, although, other cross sections of telescopic rod 200, such as elliptical, rectangular or square could be used. As illustrated in FIG. 2A, external member 122 has a diameter larger than internal member 126 of telescopic rod 200 has. In another example (not shown), external member 126 could have a diameter larger or be wider than the diameter of internal member 122. In some examples, a locking arrangement 220 to maintain external member 122 and internal member 126 of telescopic rod 200 in expanded state could be used. An example of a locking arrangement 220 can be a screw that can fix external member 122 and internal member 126 of telescopic rod 200 to each other. Alternatively, a pin could be used as locking arrangement 220 instead of a locking screw.

FIG. 2B illustrates a side view of another example of a telescopic-rod 240 for an active alerting flag. The other example of the telescopic rod comprises a clip-on-window mechanism 252. The clip-on-window mechanism 252 can be placed on the top edge of a window 260 that is closest to the traffic lane of the coming traffic.

A stress-release mechanism or impact dumping mechanism 244 could be added in between the clip-on-window mechanism 252 and the external member 122. The stress-release mechanism 244 could be configured to absorb shocks. Stress-release mechanism or impact dumping mechanism 244 can be configured to deliver certain flexibility of telescopic rod 240, isolates active-alerting flag 114 from the window 218 and protects window 218 and telescopic rod 240 form destruction by passing vehicles.

In a further example, telescopic rod and stress-release mechanism or impact dumping mechanism 244 could be replaced by a rod 240 implemented as a conical spring that could have two states—a contracted state and an expanded state. Rod 240 also supports certain flexibility and isolates active-alerting flag 114 from window 218 and protects window 218 and rod 240 with attached to it active alerting flag form destruction by passing vehicles.

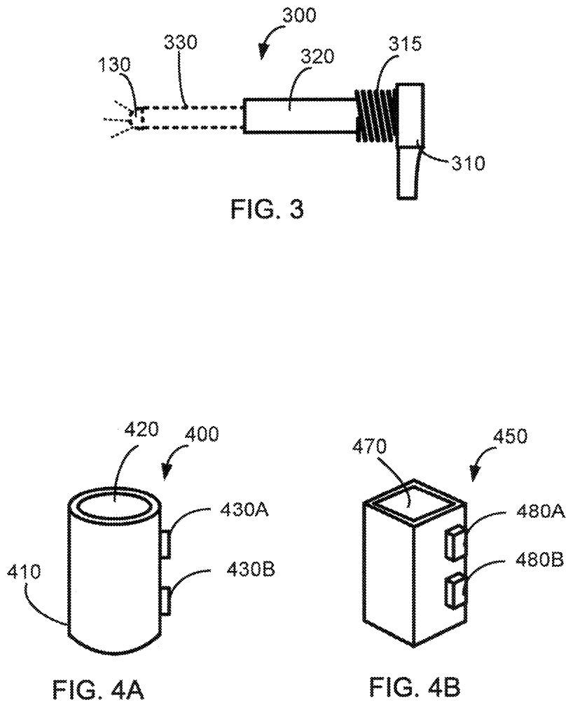

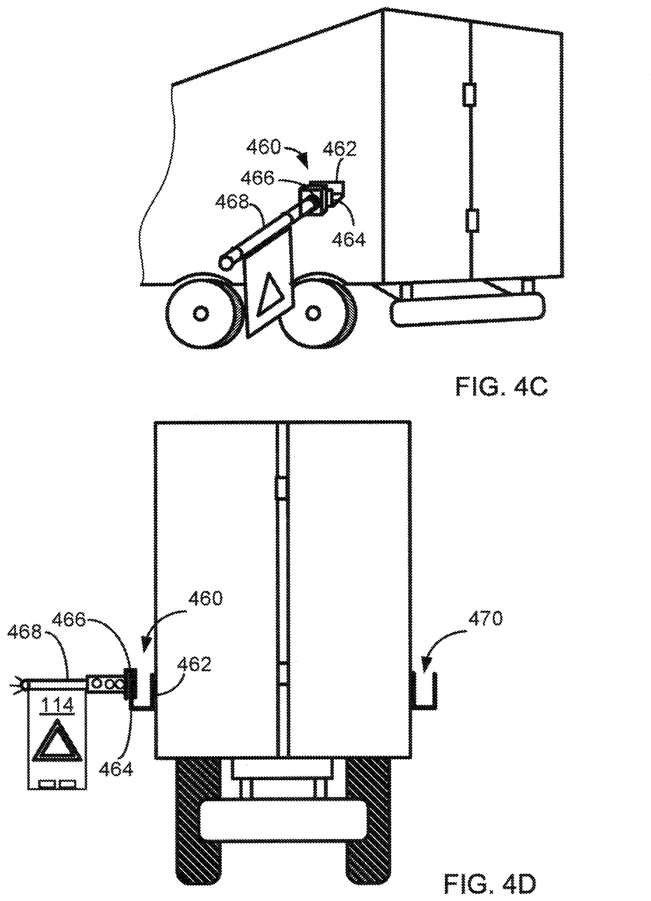

FIG. 3 illustrates another example of a telescopic-rod. Telescopic rod 300 that can be placed or mounted on a side or back of a bus or a wagon of a truck. Telescopic rod 300 comprises an external member 320 and the internal member 330 and stress-release mechanism or impact dumping mechanism 315. Mechanism 315 associates external member 320 with a vertical member 310. Vertical member 310 can be configured to match an adaptor (element 400 in FIG. 4A or 450 in FIG. 4B) secured to the side or back of the truck. Securing the adaptor to the side or back of the truck can be done for example, by welding the adaptor or attaching it with screws or rivets.

Some examples of telescopic rod 300 may comprise a compartment for batteries to provide power supply to energizing the one or more light sources 130. The compartment for batteries (not shown) can be included in vertical member 310.

FIG. 4A illustrates an example of adaptor for holding the active alerting flag. Adaptor 400 can be secured to the back or side of a truck or a track trailer. Adaptor 400 can be produced from a pipe 410 that has a cylindrical shape with a cross section of a circle 420 and one or more bulges 430A and 430B. Bulges 430A and 430B can be used to attach adaptor 400 to a side or back of a vehicle. Bulges 430A and 430B could be welded or attached by screws to the side or back of the vehicle. In some examples adaptor 400 could house a stress-release mechanism or impact dumping mechanism (not shown in the figures) for preventing the active alerting flag to be thrown away by passing traffic.

FIG. 4B illustrates another example of adaptor 450 for holding an active alerting flag at a side of a truck or track trailers. Adaptor 450 has a cylinder with a square cross section 470 and one or more bulges 480A and 480B that could be used to attach adaptor 450 to a side or back of a vehicle. Bulges 480A and 480B could be welded or attached by screws to the side or back of the vehicle. In some examples adaptor 450 could house a stress-release mechanism or impact dumping mechanism (not shown in the figures) for preventing the active alerting flag to be thrown away by passing traffic.

FIG. 4C is an isometric view of another example of an adaptor for holding the active alerting flag at a side of a truck or track trailers. Adaptor 460 has a shape of the English letter U. The external upright member 464 of the U shape adaptor is adapted to simulate the edge of a window. The internal upright member 462 of the U shape adaptor is adapted to be attached to the side of a truck or to the back of the track, close to the line where side and the back end of the truck intersect. Internal arm of adaptor 462 could be attached to the side of the truck for example by welding or screws.

Since the external upright member 464 of the U shape adaptor 460 is configured to simulate the edge of a truck window, a clip-on-window mechanism 466 similar to clip-on-window mechanism 210 (FIG. 2) could be used to attach active alerting flag to adaptor. Other active alerting flag attachment elements such as stress-release mechanism or impact dumping mechanism 244 (FIG. 2) could be mutatis mutandis applied to attach active alerting flag 468 to external upright member 464.

FIG. 4D is a back view of an adaptor for holding the active alerting flag at a side of a truck or track trailer. The figure illustrates a back side of the wagon of the truck with an active alerting flag 468. In this example, the back of the wagon comprises two U-shaped adaptors 460 and 470. Each U-shape adaptor is associated with a different side of the track. The internal upright member 462 is attached to the left side of the wagon, close to the back of the wagon. The external arm 464 of the U-shaped adaptor is configured to accept clip-on-window mechanism 466 that has the shape of an inverse U letter. In some examples U-shaped adaptor 460 may comprise a holding mechanism (not shown in the figures) for preventing active alerting flag 468 to be thrown away and destroyed by passing traffic. An example of a holding mechanism can comprise a screw that penetrates the clip-on-window mechanism 466 and entered the external arm 464. In some of examples of adaptor 400, 450, and/or 460 may be further configured to energize the one or more light sources of the active alerting flag. Energizing the light sources can be done by the accumulator of the standing vehicle.

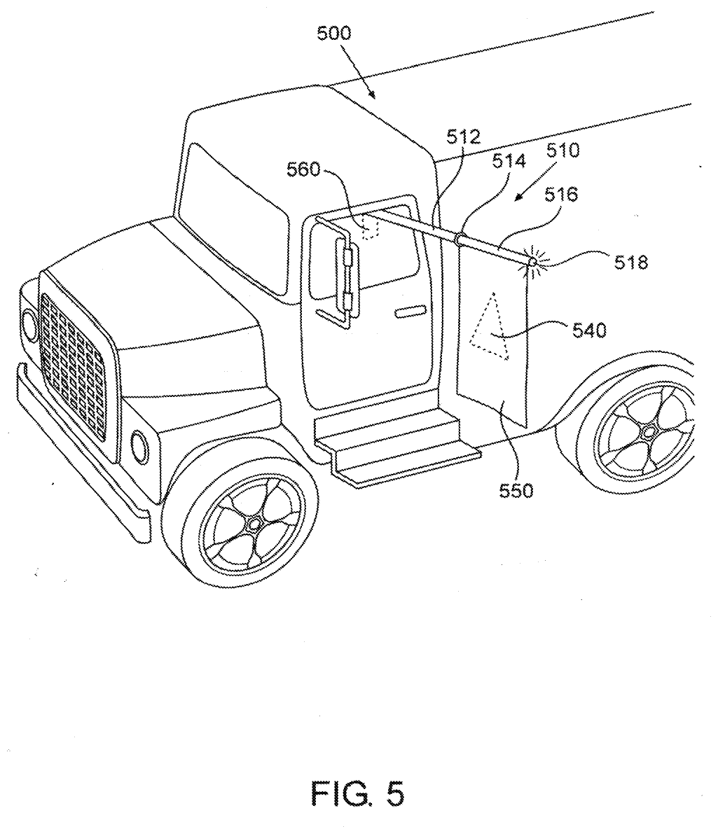

FIG. 5 illustrates an example of a standing truck 500 with active alerting flag. Active alerting flag 510 is attached to driver's window of truck 500. Active alerting flag 510 comprises a clip-on window mechanism 560 that is placed on the top edge of the window. Clip-on window mechanism 560 can be captured between the top edge of the window and the frame of the window. In one example active alerting flag 510 may comprise a telescopic-rod having an external member 512 and an internal member 516. Internal member 516 can be pulled on a desired length from external member 512. In some examples external member 512 may include a locking mechanism 514 that tightens the edge of the external member 512 with the pulled internal member 516. In some examples of active alerting flag 510, the edge of internal member 516 may comprise a light source 518.

Internal member 516 can be associated with a fabric 550. Fabric 550 can be made of high strength polyester material. In other examples of active alerting flag 510 fabric 550 can be made from cotton. The width of active alerting flag 510 fabric 550 can be few tens of centimeters, for example 30 to 60 centimeters. The height or length of fabric 550 can be few tens of centimeters, for example 50 to 100 centimeters.

An example of fabric 550 may comprise one or more reflection bands 540. In some examples of active alerting flag 510, the reflection bands 540 can be in a shape of a triangle. Yet, in some embodiments reflection bands 540 can be associated with one or more light sources such as LEDs emitting red light or yellow light.

FIG. 6A illustrates an example of an adaptor for holding the active alerting flag on a back 610 of a truck 600. Adaptor 630 could be a rectangular or square cylindrical body with a round or other cross section hole configured to receive an alerting active flag or triangle. Adaptor 630 could be attached to the back door 620 of a truck 600 by welding or by different types of fasteners.

FIG. 6B illustrates another example of an adaptor for holding the active alerting flag on a roof 615 or back 620 of truck 650. The figure illustrates a standing truck 650 with active alerting flag adaptor 660. Adaptor 660 can be a cylindrical body with a round cross section. Adaptor 660 could be attached to the back door 620 of the truck 615 similar to adaptor 630 means. Active alerting flag 624 could include a telescopic-rod 640 and a fabric 670. Telescopic-rod 640 can include one or more light sources 690 mounted the distal end of telescopic rod 640 or along the one or more members of telescopic-rod 640.

Fabric 670 of may further comprise an active alerting triangle 672 or one or more reflection bands. Yet, in some examples, active alerting triangle 672 or one or more reflection bands can be formed by light source such as red LEDs.

Still in a further example of active alerting flag 624, the bottom edge of fabric 670 may include one or more weights 652 that keeps fabric 670 substantially perpendicular to the road and faces the coming traffic. In some examples weights 652 can be replaced with a chain of light source. In a further example weights 652 can be replaced by one or more batteries used to energize the light sources.

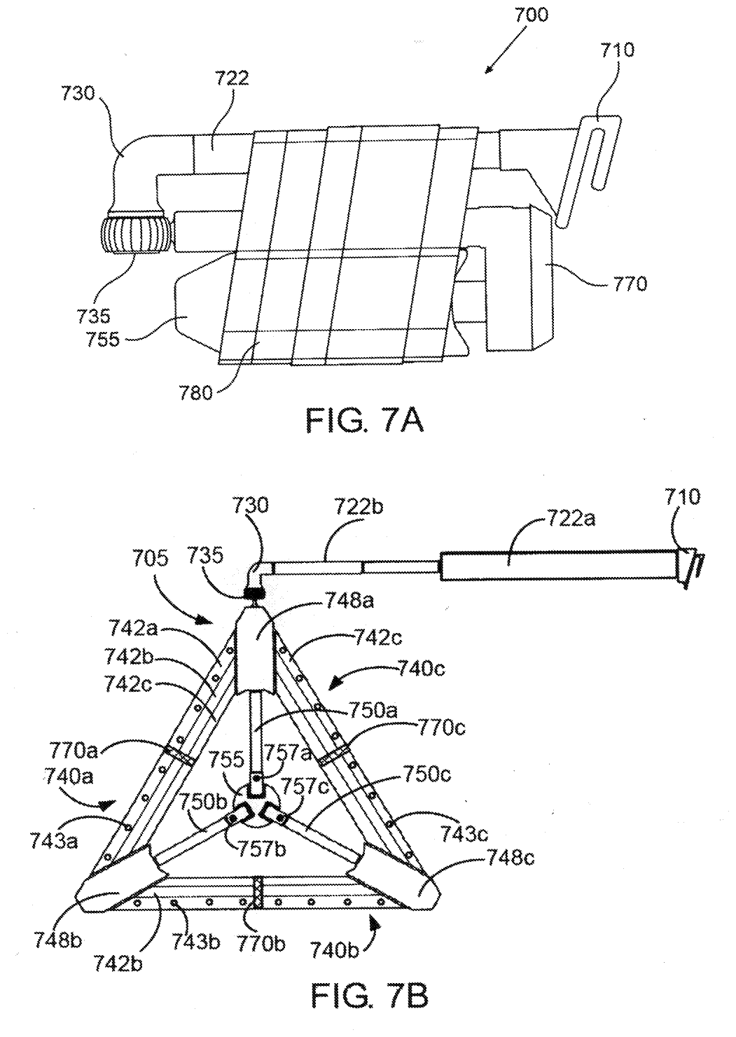

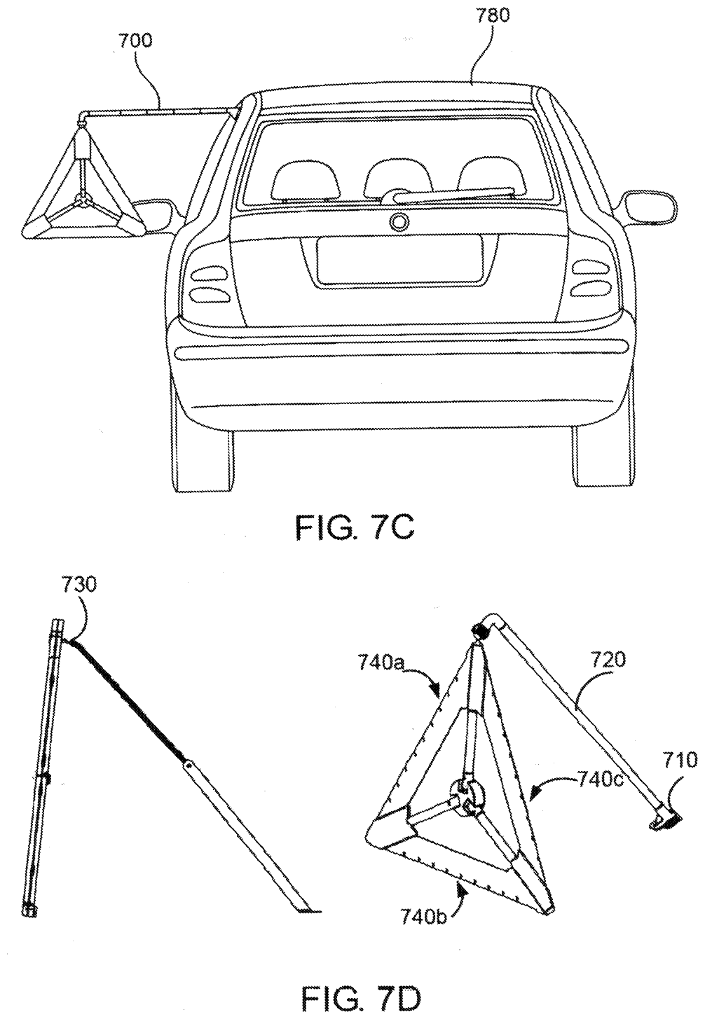

FIGS. 7A, 7B, 7C and 7D are examples illustrating different states of a folding active-alerting triangle. Folding active-alerting triangle 700 comprises a telescopic rod 720 (FIG. 7B) with a distal 704 and proximal 706 end. Telescopic rod 720 includes an external member 722a, an internal member 722b, and a clip-on-window mechanism 710 mounted on proximal end 706 of telescopic rod 720. A knee 730 terminates distal end of the internal member 722b. In another example Folding Active-Alerting Triangle 700 rod 720 can be a fixed length single piece rod.

Clip-on-window mechanism 710 is typically placed on the top edge of the window that is the closest traffic lane of the incoming traffic. For example, the window of the driver, which is the closest to the traffic lane of the incoming traffic. In some examples, rod 720 of folding active-alerting triangle 700 could be adapted to support folding active-alerting triangle 700 in a slanted position, when it is placed on the road between the incoming traffic and a standing vehicle, as it is illustrated in FIG. 7D.

Knee 730 that terminates distal end, of the internal member 722, could accommodate a joint or a pivot 735 facilitating suspension of alerting-triangle 705. In some examples of folding active-alerting triangle 700 pivot 735 could be configured to allow alerting-triangle 705 to be rotated counter clock wise toward the rod 720. Typically, active triangle 705 can be assembled of three bars 740a-c that are attached to each other forming three apexes. A pouch 748a-c can be associated with each respective apex. A discus shaped center 755 of alerting-triangle 705 accommodates three hinges 757a-c. Three rods 750a-c associated each respective hinge 757a-c with a corresponding pouch 748a-c.

Alerting-triangle 705 is an assembly of three bars 740a-c. Each of three bars 740a-c that form alerting-triangle 705 includes three stripes 742a-c. In some examples the first stripe 742a houses sources of light 743a-c. The source of light could be LEDs 743a-c, for example. The second stripe 742b can be a retro-reflecting red segment and the third stripe 742c can be red-fluorescent area (RFA). In other embodiments of the active-alerting triangle, the order of the stripes can be retro-reflecting red stripe as the first one, then red-fluorescent area, and finally LEDS stripe, as the internal segment, etc.

In one example, a joint 770a-c divides each bar 740a-c of active alerting triangle 705 into two segments connected between them by joint 770a-c respectively. When the Alerting Triangle 705 is not in use, it can be folded by pushing center part 755 outside the plane in which the active alerting triangle resides. A band 780 can hold active alerting triangle in 700 (FIG. 7A) in the folded state.

FIG. 7C illustrates a standing vehicle 780, with a foldable active alerting triangle 700 associated with a window of vehicle 780. The active side of foldable active alerting triangle 700 faces the incoming traffic.

FIG. 7D illustrates an example of foldable active alerting triangle 700 that is placed on the road. In the illustrated example, bar 740b is placed directly on the road. A telescopic rod or a fixed rod 720 support the alerting triangle in a standing position facing the incoming traffic. The clip-on-window mechanism 710 could be configured to serve as the interface between rod 720 and the road.

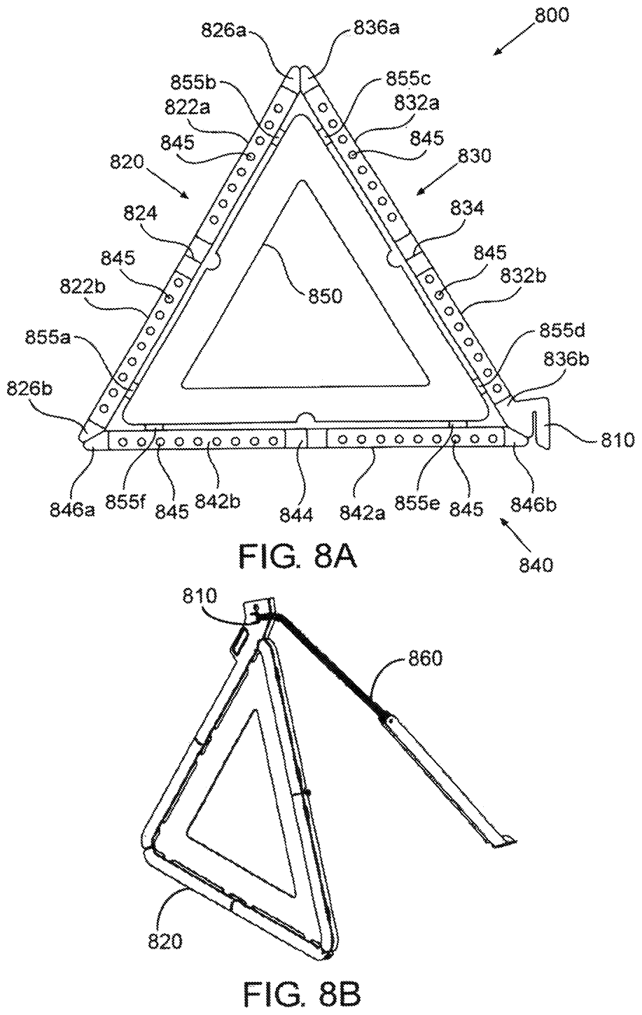

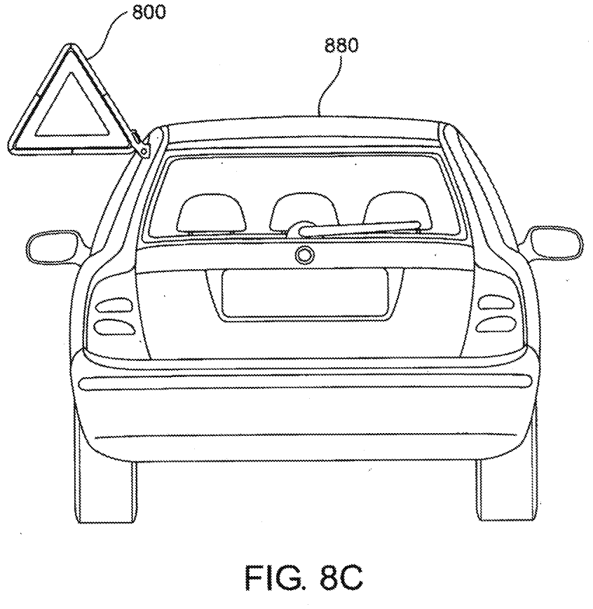

FIGS. 8A, 8B and 8C illustrate another example of a folding-active-alerting-triangle. Folding-active-alerting triangle 800 can be an assembly of two triangles: an external or first triangle and an internal or second triangle. The external triangle can have three bars 820, 830 and 840. The three bars are attached to each other at the three apexes, 826a and 836a; 826b and 846a and 846b and 836b.

Apex 836b can be associated with a clip-on-window mechanism 810. Clip-on-window mechanism 810 can be placed on the top edge of the window that is closest to the traffic lane of the incoming traffic. For example, the window of the driver. As illustrated in FIG. 8C, folded-active-alerting-triangle 800 with the help of a clip-on-window mechanism is associated with a standing vehicle 880.

In some examples (not shown in the figures) folded-active-alerting-triangle 800 could comprise a clip-on-vehicle mechanism. The clip-on-vehicle mechanism could be configured to attach an example of a folded-active-alerting-triangle—to the door of a standing vehicle or to the roof of the standing vehicle. The clip-on-vehicle mechanism could be a magnetic or a vacuum mechanism.

Each one of bars 820, 830 and 840 can be associated with a plurality of LEDs, illustrated as white spots 845 distributed along each bar 820, 830 and 840 (FIG. 8A). The LEDs can light in red color or yellow color. Other examples of LEDs could be configured to emit other colors. In some examples each bar 820, 830 and 840 can be divided into two segments (822a&b, 832a&b and 842a&b, respectively). The segments are connected between them by a joint 824, 834 and 844 respectively. Each joint 824, 834 and 844 can comprise one or more pivots. The pivots allow the bars to be folded. Thus, when the folded active alerting triangle 800 is not in use it can be folded by folding the bars.

In addition, an elastic cable (not shown) can be inserted in all of the segments of the three bars. The elastic cable can be configured to pull and expand the folded triangle into the shape of an alerting triangle before placing folded active alerting triangle 800 on the road or attaching it to the vehicle. In some examples, instead of the elastic cable, a spring can be placed at each joint 824, 834. Each of the springs can be configured to push its associated folded segments to be open into a complete bar. At joint 824 the spring is configured to open the two folded segments 822a&b to open into a straight bar 820. At joint 834 the spring is configured to open the two folded segments 832a&b to open into a straight bar 830.

Internal triangle 850 can be associated with the external triangle by short connecting bands 855a-f. The internal triangle 850 can be made of fabric and be associated with stripes of retro-reflecting red area and stripes of red fluorescent area.

In one example, folded active alerting triangle 800 may comprise a telescopic-rod 860. Telescopic-rod 860 can be used to support folded active alerting triangle 800 when it is placed on the road as it illustrated in FIG. 8B. Bar 820 can be placed on the road and the telescopic-rod 860 can be associated with clip-on-window type mechanism 810. In some examples of folded active alerting triangle 800, rod 860 can be a fixed rod and not a telescopic one.

In the description and claims of the present application, each of the verbs, “comprise”, “include” “have”, and “conjugate” thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module.

It will be appreciated by persons skilled in the art that the present active alerting flag and triangle are not limited by what has been particularly shown and described herein above. Rather the scope of the active alerting flag and triangle is defined by the claims that follow.

1. An active-alerting system, comprising:
a clip-on-vehicle mechanism configured to be associated with a standing vehicle; and a triangle;
wherein the active-alerting system is associated with at least one light source; and
wherein the plane of the triangle, when the clip-on-vehicle mechanism is associated with the standing vehicle, is substantially perpendicular to a side of the standing vehicle.

2. (canceled)

3. The active-alerting system of claim 1, wherein the clip-on-vehicle mechanism is associated with a rod.

4. (canceled)

5. The active-alerting system of claim 1, wherein the clip-on-vehicle mechanism is configured to be associated with a top edge of a window of the standing vehicle.

6. The active-alerting system of claim 1, wherein the clip-on-vehicle mechanism further comprises a stress-release mechanism, wherein the stress-release mechanism is configured to absorb shocks caused by punches from passing cars.

7. The active-alerting system of claim 3, wherein the stress-release mechanism is placed near to the standing vehicle.

8. (canceled)

9. The active-alerting system of claim 1, wherein the clip-on-vehicle mechanism further comprises a magnetic mechanism.

10. The active-alerting system of claim 2, wherein the active-alerting system is an active-alerting flag comprises a piece of fabric with the triangle embedded in the piece of fabric.

11. The active-alerting system of claim 6, wherein the rod and the piece of fabric are arranged such that when the active-alerting flag is associated with the vehicle, the piece of fabric is substantially perpendicular to the standing vehicle and is substantially perpendicular to the road.

12. The active-alerting system of claim 6, wherein the at least one light source is embedded in the piece of fabric.

13. The active-alerting system of claim 6, wherein the piece of fabric further comprises at least one reflection band.

14. (canceled)

15. The active-alerting system of claim 1, further comprising an adaptor for holding an active-alerting system in association with a side of a standing wagon of a truck.

16. The active-alerting system of claim 10, wherein the adaptor has a U-shape, wherein one arm of the U-shape is associated with the wagon and the other arm of the U-shape simulate the top edge of the driver's window.

17-20. (canceled)

21. An Active-Alerting Triangle, comprising:
three bars, wherein the three bars are configured to be assembled as a triangle;
a clip-on-vehicle mechanism, wherein the clip-on-vehicle mechanism is configured to associate the active-alerting triangle with a side of a standing vehicle; and
wherein at least one bar is associated with at least one light source, a retro-reflecting red area and a red-fluorescent area.

22. The Active-Alerting Triangle of claim 12, wherein at least one bar of the three bars is divided into two or more segments connected by a joint.

23. The Active-Alerting Triangle of claim 13, wherein each joint includes at least one pivot configured to support folding of the Active-Alerting Triangle into a folded state when the active-alerting triangle is not in use.

24. The Active-Alerting Triangle of claim 14, further comprising an elastic cable inserted in at least two segments of the same bar and wherein the elastic cable is configured to pull the folded active-alerting triangle into a triangle.

25. The Active-Alerting Triangle of claim 14, further comprising a spring in association with at least one joint and wherein the spring is configured to open the folded active-alerting triangle into a triangle.

26. The Active-Alerting Triangle of claim 12, further comprising a rod.

27. (canceled)

28. The Active-Alerting Triangle of claim 12, wherein the clip-on-vehicle mechanism is configured to be associated with a top edge of a window of the standing vehicle.

29. The Active-Alerting Triangle of claim 12, wherein the clip-on-vehicle mechanism further comprises a magnetic mechanism.

30. The Active-Alerting Triangle of claim 12, wherein the clip-on-vehicle mechanism further comprises a stress-release mechanism, wherein the stress-release mechanism is configured to absorb shocks.

31. The Active-Alerting Triangle of claim 20, wherein the stress-release mechanism further comprises a spring.
